(19) United States
(12) Patent Application Publication
(10) Pub. No.: US 2013/0039524 A1
(43) Pub. Date: Feb. 14, 2013

(54) HEADBAND WITH EAR BUDS

(71) Applicant: Brandon Jones, Naples, FL (US)

(72) Inventor: Brandon Jones, Naples, FL (US)

(21) Appl. No.: 13/209,411

(22) Filed: Aug. 14, 2011

(51) Int. Cl. H04R 1/10

(52) U.S. Cl. 381/378

(57) ABSTRACT

The present invention is a headband that includes a base headband with two sides that is worn around a user's head, a pair of ear buds that provide music and sound to the user that are inserted into the user's ears while the headband is in use and a pair of sound wires with a proximal end and a distal end that are in communication with the ear buds. The headband also includes a slot with a front that includes a dear window disposed on the front of the slot that holds an audio playing device such as an MP3 player and a pair of storage apertures disposed on the base headband to store the ear buds.

### TECHNICAL FIELD & BACKGROUND

Currently there are limited options for supporting devices that allow for hands-free media enjoyment. Individuals who like musical stimulation while engaging in physical tasks, such as sports or traveling, are often restricted in the process due to frequent entanglement of wires and partial mobility.

The present invention generally relates to a headband. More specifically, the invention is a headband with ear buds.

It is an object of the invention to provide a headband with ear buds that allows a user to listen to music while simultaneously performing an activity such as a playing a sport or traveling.

It is an object of the invention to provide a headband with ear buds that can accommodate an audio playing device.

What is really needed is a headband with ear buds that allows a user to listen to music while simultaneously performing an activity such as playing a sport or traveling that can also accommodate an audio playing device.

### BRIEF DESCRIPTION OF THE DRAWINGS

The present invention will be described by way of exemplary embodiments, but not limitations, illustrated in the accompanying drawings in which like references denote similar elements, and in which:

FIG. 1 illustrates a side perspective view of a headband, in accordance with one embodiment of the present invention.

### DETAILED DESCRIPTION OF ILLUSTRATIVE EMBODIMENTS

Various aspects of the illustrative embodiments will be described using terms commonly employed by those skilled in the art to convey the substance of their work to others skilled in the art. However, it will be apparent to those skilled in the art that the present invention may be practiced with only some of the described aspects. For purposes of explanation, specific numbers, materials and configurations are set forth in order to provide a thorough understanding of the illustrative embodiments. However, it will be apparent to one skilled in the art that the present invention may be practiced without the specific details. In other instances, well-known features are omitted or simplified in order not to obscure the illustrative embodiments.

Various operations will be described as multiple discrete operations, in turn, in a manner that is most helpful in understanding the present invention. However, the order of description should not be construed as to imply that these operations are necessarily order dependent. In particular, these operations need not be performed in the order of presentation.

The phrase “in one embodiment” is utilized repeatedly. The phrase generally does not refer to the same embodiment, however, it may. The terms “comprising”, “having” and “including” are synonymous, unless the context dictates otherwise.

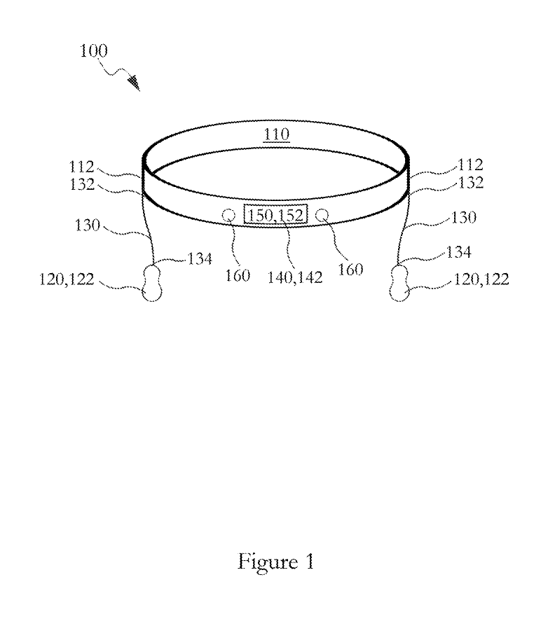

FIG. 1 illustrates a side perspective view of a headband 100, in accordance with one embodiment of the present invention. The headband 100 includes a base headband 110, a pair of ear buds 120, a pair of sound wires 130, a slot 140 and a pair of storage apertures 150. The headband 100 also stretches as needed to accommodate any size head of a user.

The base headband 110 has two sides 112 at an approximate 3 o'clock and 9 o'clock position and is made of an absorbent cotton blend that is worn around a user's head, although the base headband 110 can be made of other suitable material such as cotton or polyester. The ear buds 120 provide music and sound to the user and are inserted into the user's ears while the headband 100 is in use. The ear buds 120 also have a plastic cover 122 on each ear bud 120 for protection and hygiene purposes. The sound wires 130 have a proximal end 132 and a distal end 134. The ear buds 120 are attached to the distal ends 134 of the sound wires and the sides 112 of the base headband are attached to the proximal ends 132 of the ear bud wires. The slot 140 has a front 142 that includes a clear plastic window 144 disposed on the front 142 of the slot. The slot 140 can also accommodate and hold an audio playing device 160 that is in communication with the ear buds 120. The audio playing device 160 can be an MP3 player 162 or other suitable audio playing device 160. The storage apertures 160 are disposed adjacent to said slot 140 and can be utilized to store the ear buds 120 within the headband 100, although the storage apertures 160 can be disposed on any suitable location on the headband 100.

The headband is a headband with an MP3 player and a pair of ear bud components that functions as a media support accessory. Made from a lightweight cotton-blend fabric with a protective window section holding an internal music player, the headband stretches to varying widths to ensure a comfortable fit regardless of the user. Once positioned, the user can select which MP3 audio files they wish to hear and place the suspended ear buds into their ear canals in order to take pleasure in a hands-free listening experience. The headband can also be marketed in varying colors and styles to appeal to diverse consumers.

The headband functions as a portable, sweat absorbing modern music device. The feature of a comfortable headband, with an embedded MP3 player and minute ear buds, facilitates the act of performing various physical tasks while enjoying a personal musical collection.

While the present invention has been related in terms of the foregoing embodiments, those skilled in the art will recognize that the invention is not limited to the embodiments described. The present invention can be practiced with modification and alteration within the spirit and scope of the appended claims. Thus, the description is to be regarded as illustrative instead of restrictive on the present invention.

1. A headband, comprising:
a base headband with two sides that is worn around a user's head;
a pair of ear buds that provide music and sound to said user that are inserted into said user's ears while said headband is in use;
a pair of sound wires with a proximal end and a distal end that are in communication with said ear buds; and
a slot with a front that includes a dear window disposed on said front of slot that holds an audio playing device.

2. The headband according to claim 1, wherein said base headband is made of absorbent cotton blend material.

3. The headband according to claim 1, wherein said base headband sides are in an approximate 3 o'clock and approximate 9 o'clock position along said base headband.

4. The headband according to claim 1, wherein said ear buds each have a plastic cover.

5. The headband according to claim 1, wherein said ear buds are attached to said distal ends of sound wires and said sides of base headband are attached to said proximal ends,

6. The headband according to claim 1, wherein said headband stretches to accommodate any sized said user's head.

7. A headband, comprising:
a base headband with two sides that is worn around a user's head;
a pair of ear buds that provide music and sound to said user that are inserted into said user's ears while said headband is in use;
a pair of sound wires with a proximal end and a distal end that are in communication with said ear buds;
a slot with a front that includes a dear window disposed on said front of slot that holds an audio playing device; and
a pair of storage apertures disposed on said base headband to store said ear buds.

8. The headband according to claim 7, wherein said base headband is made of absorbent cotton blend material.

9. The headband according to dam 7, wherein said base headband sides are in an approximate 3 o'clock and approximate 9 o'clock position along said base headband.

10. The headband according to claim 7, wherein said ear buds each have a plastic cover.

11. The headband according to claim 7, wherein said ear buds are attached to said distal ends of sound wires and said sides of base headband are attached to said proximal ends.

12. The headband according to claim 7, wherein said headband stretches to accommodate any sized said user's head.

13. A headband, comprising:
a base headband with two sides that is worn around a user's head;
a pair of ear buds that provide music and sound to said user that are inserted into said user's ears while said headband is in use:
a pair of sound wires with a proximal end and a distal end that are in communication with said ear buds;
a slot with a front that includes a clear window disposed on said front of slot that holds an audio playing device; and
a pair of storage apertures disposed on said base headband to store said ear buds.

14. The headband according to claim 13, wherein said base headband is made of absorbent cotton blend material.

15. The headband according to claim 13, wherein said base headband sides are in an approximate 3 o'clock and approximate 9 o'clock position along said base headband.

16. The headband according to claim 13, wherein said ear buds each have a plastic cover,

17. The headband according to cairn 13, wherein said ear buds are attached to said distal ends of sound wires and said sides of base headband are attached to said proximal ends,

18. The headband according to claim 13, wherein said audio playing device is an MP3 player.

19. The headband according to claim 13, wherein said storage apertures are disposed adjacent to said slot.

20. The headband according to cairn 13, wherein said headband stretches to accommodate any sized said user's head.
